(19) United States
(12) Patent Application Publication
(10) Pub. No.: US 2010/0163409 A1
(43) Pub. Date: Jul. 1, 2010

(54) POWER SUPPLY CONNECTION STRUCTURE AND ELECTROLYTIC PROCESSING DEVICE

(76) Inventors: Akira MASUDA, Shizuoka-ken (JP); Keiko KAWARASAKI, Shizuoka-ken (JP); Yasuhiro MASUDA, Shizuoka-ken (JP)

Correspondence Address: BIRCH STEWART KOLASCH & BIRCH, PO BOX 747, FALLS CHURCH, VA, 22040-0747, US

(21) Appl. No.: 12/637,430

(22) Filed: Dec. 14, 2009

(30) Foreign Application Priority Data
Dec. 26, 2008 (JP) 2008-334496

(51) Int. Cl. C25F 7/00; H01R 4/00; C25D 17/00

(52) U.S. Cl. 204/275.1; 439/345; 439/283

(57) ABSTRACT

A power supply connection structure which effectively suppresses heat generation at a connection portion at which a feeder wire, that supplies current to an electrode, is connected to the electrode, and an electrolytic processing including the power supply connection structure are provided. The power supply connection structure includes: a rod-shaped electrode having a reduced-diameter portion having a diameter that is reduced toward an end of the electrode; a conductive power supply member which is connected a feeder wire and has an inner cavity into which the reduced-diameter portion is inserted; and a coil spring which pushes the power supply member toward the reduced-diameter portion, wherein the side wall surface of the inner cavity closely contacts an outer peripheral surface of the reduced-diameter portion, and a gap is formed between the base surface of the inner cavity and the end surface at the reduced-diameter portion of the electrode.

### CROSS-REFERENCE TO RELATED APPLICATION

This application claims priority under 35 USC 119 from Japanese Patent Application No. 2008-334496 filed on Dec. 26, 2008, the disclosure of which is incorporated by reference herein.

### BACKGROUND OF THE INVENTION

1. Field of the Invention

The present invention relates to a power supply connection structure and an electrolytic processing device. In particular, the present invention relates to a power supply connection structure that can effectively suppress heat generation at a connection portion at which a feeder wire, that supplies current to an electrode, is connected to the electrode and an electrolytic processing device.

2. Description of the Related Art

A heat-generating body assembly exists that is cylindrical and in which heat-generating bodies, that are made of graphite and formed in partial cylinder shapes, are joined by a connector made of graphite (Japanese Patent Application Laid-Open (JP-A) No. 58-089790). In this heat-generating body assembly, a terminal is securely mounted to a hole formed in the connector, and a power supply line is connected to the terminal.

Further, a battery terminal exists that has an electrode holding portion formed by bending a metal, strip-like member into an annular form, a pair of leg pieces that extend outwardly from both sides of the electrode holding portion in an opposing manner, and a bolt attached through the both leg pieces. By causing the pair of leg pieces to deform in directions approaching one another by tightening the bolt, the electrode holding portion is deformed such that the diameter thereof is reduced, and is pushed against and connected to the electrode of a battery that is fitted to the interior of the electrode holding portion (JP-A No. 11-054183).

### SUMMARY OF THE INVENTION

The present invention has been made in view of the above circumstances and provides a power supply connection structure and an electrolytic processing device including the power supply connection structure.

According to a first aspect of the invention, a power supply connection structure includes:
an electrode which has at least one end portion that is a rod-shaped portion, and which has, in a vicinity of an end surface of the rod-shaped portion, a reduced-diameter portion having a diameter that is reduced toward the end surface;
a power supply member which is formed from a conductor and to which is connected a feeder wire that supplies current to the electrode, the power supply member having an inner cavity that is a concave portion formed such that the circumference of a side wall of the inner cavity is reduced toward a base surface of the inner cavity, and, due to the reduced-diameter portion of the electrode being inserted in the inner cavity, the power supply member is attached to the reduced-diameter portion of the electrode; and
a biasing member which pushes the power supply member, that is attached to the reduced-diameter portion of the electrode, toward the reduced-diameter portion, wherein the power supply member is formed such that, in a state in which the power supply member is attached to the reduced-diameter portion of the electrode, the side wall surface of the inner cavity closely contacts an outer peripheral surface of the reduced-diameter portion of the electrode, and a gap is formed between the base surface of the inner cavity and the end surface of the electrode at the reduced-diameter portion of the electrode.

According to a second aspect of the invention, an electrolytic processing device includes:
an electrolysis tank in which an electrolytic processing liquid is stored;
a web conveying unit for conveying a web, which is to be subjected to electrolytic processing, through the interior of the electrolysis tank along a predetermined conveying path; and
an electrode that is disposed at the interior of the electrolytic tank along the conveying path of the web, and to which a feeder wire is connected by the power supply connection structure according to the first aspect,

wherein the electrolytic processing device electrolytically processes the web by supplying alternating current or direct current through the feeder wire to the electrode.

### BRIEF DESCRIPTION OF THE DRAWINGS

FIG. 1 is a partial sectional view illustrating the structure of a power supply connection portion according to exemplary embodiment 1 of the present invention, which is cut along the axial direction of the power supply connection portion;

FIG. 2A to FIG. 2C are explanatory diagrams showing the operation of the power supply connection portion shown in FIG. 1;

FIG. 3 is a partial sectional view illustrating the structure of a power supply connection portion according to another exemplary embodiment of the present invention, which is cut along the axial direction of the power supply connection portion;

FIG. 4 is a partial sectional view illustrating the structure of a power supply connection portion according to yet another exemplary embodiment of the present invention, which is cut along the axial direction of the power supply connection portion;

FIG. 5 is a graph showing changes in contact resistance in accordance with heat cycles in Example 1, Comparative Example 1, and Comparative Example 2;

FIG. 6 is a graph showing the results of a corrosion resistance test in Example 1, Comparative Example 1, and Comparative Example 2;

FIG. 7A and FIG. 7B are partial sectional views showing the structure of a power supply connection portion used in Comparative Example 1; and

FIG. 8A and FIG. 8B are partial sectional views showing the structure of a power supply connection portion used in Comparative Example 2.

### DETAILED DESCRIPTION OF THE INVENTION

An electrode that is formed from a material such as graphite or the like is used in an electrolytic processing tank in which electrolytic processing is carried out on a metal web such as an aluminum web or the like.

A connection portion, for connecting a feeder wire that supplies alternating current or direct current, is provided at the electrode.

Here, usually current of 500 amperes or more is supplied to one electrode in the electrolytic processing tank. Therefore, even if the contact resistance at the connection portion is around 1 mΩ, heat generation of greater than or equal to 100° C. is caused at the connection portion.

For example, an acidic electrolytic liquid is used in an electrolytic surface roughening tank that is an example of an electrolytic processing tank, in which an aluminum web is subjected to electrolytic surface roughening so as to make it the support web of a lithographic printing plate. Because the corrosiveness of the acidic electrolytic liquid is high, a hard vinyl chloride resin is usually used for the electrolytic surface roughening tank from the standpoint of achieving both corrosion-resistance and insulation.

However, even if the hard vinyl chloride resin is heat-resistant grade, it only has heat-resistance of about 100° C. Accordingly, if heat generation of greater than or equal to 100° C. arises at the connection portion at the electrode, the respective members of the electrolytic surface roughening tank will soften and deform due to the thermal effects from the connection portion. Therefore, there may be problems such as abnormalities may arise in the quality of the obtained support web due to the change in distance between the aluminum web and the electrode, or the acidic electrolytic liquid may leak-out from the electrolytic surface roughening tank, or the like.

The present invention approaches these problems, and an object thereof is to provide a power supply connection structure that can effectively suppress heat generation at a connection portion between a feeder wire and an electrode even when large current is supplied to the electrode, and an electrolytic processing device in which a feeder wire is connected to an electrode by the power supply connection structure.

Exemplary embodiments of the present invention will be described below.

According to a first exemplary embodiment of the invention, there is provided a power supply connection structure including:
an electrode which has at least one end portion that is a rod-shaped portion, and which has, in a vicinity of an end surface of the rod-shaped portion, a reduced-diameter portion having a diameter that is reduced toward the end surface;
a power supply member which is formed from a conductor and to which is connected a feeder wire that supplies current to the electrode, the power supply member having an inner cavity that is a concave portion formed such that the circumference of a side wall of the inner cavity is reduced toward a base surface of the inner cavity, and, due to the reduced-diameter portion of the electrode being inserted in the inner cavity, the power supply member is attached to the reduced-diameter portion of the electrode; and
a biasing member which pushes the power supply member, that is attached to the reduced-diameter portion of the electrode, toward the reduced-diameter portion,

wherein the power supply member is formed such that, in a state in which the power supply member is attached to the reduced-diameter portion of the electrode, the side wall surface of the inner cavity closely contacts an outer peripheral surface of the reduced-diameter portion of the electrode, and a gap is formed between the base surface of the inner cavity and the end surface of the electrode at the reduced-diameter portion of the electrode.

According to a second exemplary embodiment of the invention, in the power supply connection structure of the first exemplary embodiment, the biasing member includes a spring member which pushes the power supply member toward the reduced-diameter portion of the electrode.

According to a third exemplary embodiment of the invention, in the power supply connection structure of the first exemplary embodiment, a sealing member, which prevents external air and liquid from entering between the inner cavity and the reduced-diameter portion of the electrode, is provided in a vicinity of an edge portion at the inner cavity of the power supply member.

According to a fourth exemplary embodiment of the invention, in the power supply connection structure of the first exemplary embodiment, a communication path, which communicates the inner cavity with the exterior of the structure, is provided at the power supply member.

According to a fifth exemplary embodiment of the invention, the power supply connection structure of the fourth exemplary embodiment, further including a dry air supply unit which supplies dry air, via the communication path of the power supply member, to a space between the inner cavity of the power supply member and the reduced-diameter portion of the electrode.

According to a sixth exemplary embodiment of the invention, the power supply connection structure of the fourth exemplary embodiment, further including an inert gas supply unit which supplies inert gas, via the communication path of the power supply member, to a space between the inner cavity of the power supply member and the reduced-diameter portion of the electrode.

According to a seventh exemplary embodiment of the invention, there is provided an electrolytic processing device including:
an electrolysis tank in which an electrolytic processing liquid is stored;
a web conveying unit for conveying a web, which is to be subjected to electrolytic processing, through the interior of the electrolysis tank along a predetermined conveying path; and
an electrode that is disposed at the interior of the electrolytic tank along the conveying path of the web, and to which a feeder wire is connected by the power supply connection structure of the first exemplary embodiment,

wherein the electrolytic processing device electrolytically processes the web by supplying alternating current or direct current through the feeder wire to the electrode.

In accordance with the first exemplary embodiment of the present invention, in the power supply connection structure, in a state in which the power supply member is attached to the reduced-diameter portion of the electrode, the side wall surface of the inner cavity of the power supply member closely contacts the outer peripheral surface of the reduced-diameter portion of the electrode. Therefore, the contact resistance between the power supply member and the electrode is small.

When a large current is made to flow to the electrode in this state, the power supply member is heated by the electrical resistance and thermally expands. However, because the power supply member is pushed toward the reduced-diameter portion of the electrode by the biasing member, the closely contacting state of the inner cavity of the power supply member and the reduced-diameter portion of the electrode is maintained even after the thermal expansion of the heated power supply member. Accordingly, even when a large current flows to the electrode, a gap is not formed between the power supply member and the electrode, and the contact resistance does not increase. Therefore, the generation of heat at the portion of the electrode to which the power supply member is attached is effectively suppressed.

In accordance with the second exemplary embodiment of the present invention, at the power supply connection structure, the power supply member is pushed toward the reduced-diameter portion of the electrode by a spring member included in the biasing member. Accordingly, an actuator for pushing the power supply member toward the reduced-diameter portion of the electrode using oil pressure, air pressure or a ball screw mechanism, is not needed.

In accordance with the third exemplary embodiment of the present invention, at the power supply connection structure, sealing member which prevents entry of external air and a liquid such as an electrolytic liquid or the like, is provided in a vicinity of the edge portion at the inner cavity of the power supply member. Therefore, in a state in which the power supply member is attached to the reduced-diameter portion of the electrode and is pushed by the biasing member, the space that is formed by the inner cavity of the power supply member and the reduced-diameter portion of the electrode, is sealed by the sealing member, whereby liquid such as an electrolytic liquid and external air do not enter into this space. Accordingly, even in a corrosive environment, oxidation of the inner cavity surface of the power supply member due to an ambient corrosive gas entering the space between the power supply member and the electrode, and an increase in the contact resistance between the power supply member and the electrode, are effectively prevented.

In accordance with the fourth exemplary embodiment of the present invention, in the power supply connection structure, a communication path, that communicates the inner cavity with the exterior of the structure, is provided at the power supply member. Therefore, the operation of the biasing member is not impeded by air that exists in a space between the power supply member and the reduced-diameter portion of the electrode.

In accordance with the fifth exemplary embodiment of the present invention, in the power supply connection structure, a dry air supply unit is connected to the communication path. Therefore, even when the power supply connection structure is used in a corrosive environment, a surrounding corrosive gas does not enter the space between the power supply member and the reduced-diameter portion of the electrode from the communication path. Oxidation of the inner cavity surface of the power supply member due to the corrosive gas, and an increase in the contact resistance between the power supply member and the electrode that is caused thereby, are effectively prevented.

In accordance with a sixth exemplary embodiment of the present invention, in the power supply connection structure, an inert gas supply unit is connected to the communication path. Therefore, even when the power supply connection structure is used in a corrosive environment, a surrounding corrosive gas does not enter the space between the power supply member and the reduced-diameter portion of the electrode from the communication path. Oxidation of the inner cavity surface of the power supply member due to the corrosive gas, and an increase in the contact resistance between the power supply member and the electrode that is caused thereby, are effectively prevented.

In accordance with a seventh exemplary embodiment of the present invention, in an electrolytic processing device, a feeder wire is connected to an electrode by the power supply connection structure of claim 1. Therefore, even when using, as the electrolytic processing liquid, an acidic electrolytic liquid such as the aqueous solution of a strong acid such as hydrochloric acid, sulfuric acid, nitric acid, phosphoric acid or sulfonic acid, generation of heat at the connection portion between the electrode and the feeder wire can be effectively suppressed, and deformation of or damage to the electrolysis tank that is caused by this heat generation can be effectively prevented.

### 1. Exemplary Embodiment 1

A power supply connection structure, that is an example of the power supply connection structure according to the present invention and has a power supply connection portion that connects a feeder wire to a rod-shaped electrode, will be described hereinafter.

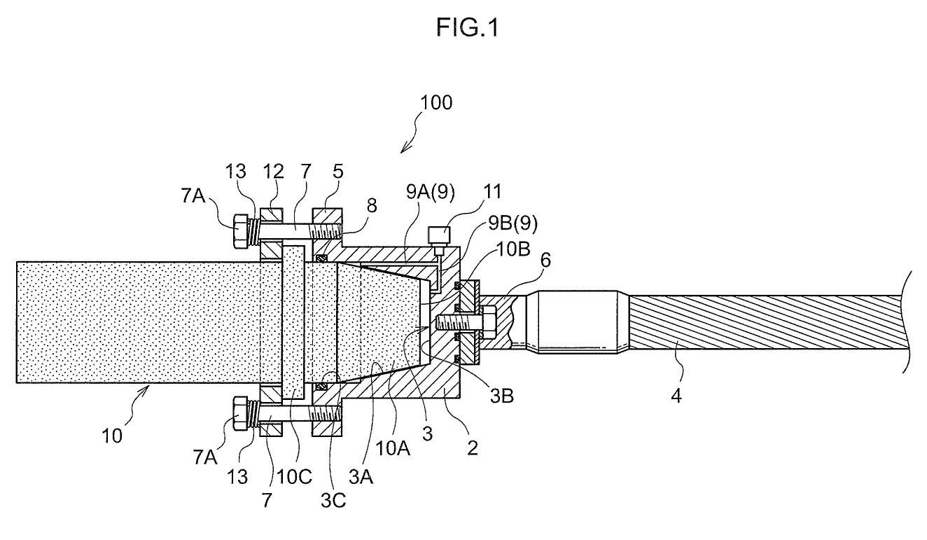

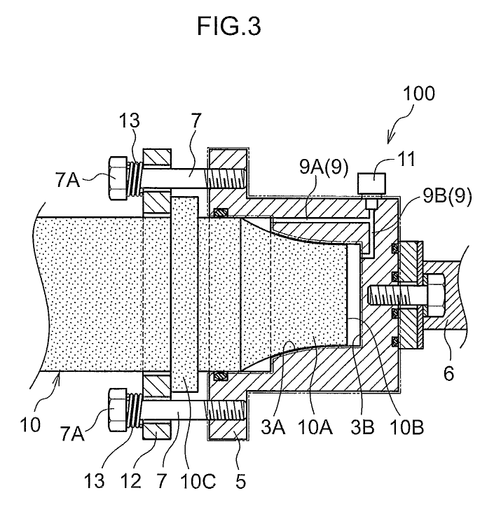

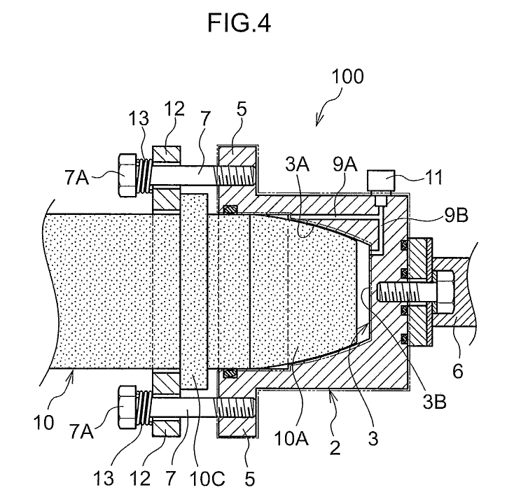

As shown in FIG. 1, a power supply connection portion 100 according to exemplary embodiment 1 has at least: a rod-shaped electrode 10 that is shaped as a circular rod and that has, at one end portion thereof, a reduced-diameter portion 10A whose diameter decreases in a conical shape toward an end surface 10B at that end portion; a power supply member 2 that covers the reduced-diameter portion 10A of the rod-shaped electrode 10; and a feeder wire 4 that is electrically connected to the power supply member 2 via a terminal 6. The shape of the outer peripheral surface of the reduced-diameter portion 10A is not particularly limited provided that the outer diameter thereof decreases toward the end surface 10B. Alternatively to the conical surface shape shown in FIG. 1, the outer peripheral surface may have, for example, a concave surface shape that is a rotating surface that is concave toward the inner side as shown in FIG. 3, or a swollen surface shape that is a rotating surface that swells toward the outer side as shown in FIG. 4.

A flange portion 10C, that swells outward in the shape of a flange toward the outer side, is formed at a position, on the rod-shaped electrode 10, adjacent to the reduced-diameter portion 10A.

The power supply member 2 is, overall, formed from a good conductor such as copper or the like. An inner cavity 3, in which the reduced-diameter portion 10A is inserted, is formed in the central portion of the power supply member 2.

The inner cavity 3 has a side wall surface 3A having a circumference whose diameter is reduced in a conical shape so as to correspond to the reduced-diameter portion 10A, and a base surface 3B. The surface of the inner cavity 3 is gold plated in order to prevent oxidation. The inner cavity 3 is formed such that when the reduced-diameter portion 10A of the rod-shaped electrode 10 is inserted in the inner cavity 3, the side wall surface 3A closely contacts the side surface of the reduced-diameter portion 10A, and a gap is formed between the base surface 3B and the end surface 10B of the rod-shaped electrode 10. When the outer peripheral surface of the reduced-diameter portion 10A is a concave surface as shown in FIG. 3, the side wall surface 3A of the inner cavity 3 is made to be a swollen surface that swells inwardly. When the outer peripheral surface of the reduced-diameter portion 10A is a swollen surface as shown in FIG. 4, the side wall surface 3A is made to be a concave surface that is concave outwardly.

A flange portion 5, that swells outward in the shape of a flange toward the outer side, is formed at the end portion of the power supply member 2, which is at the inner cavity 3 entrance side.

A groove 3C is provided in the inner circumferential surface at the entrance of the inner cavity 3. An O-ring 8, that is an example of a sealing member of the present invention, is attached to the groove 3C. Instead of the O-ring 8, a lip seal such as an oil seal or U-packing, a gland packing or the like may be attached to the groove 3C as the sealing member.

A communication path 9, that communicates the inner cavity 3 with the exterior of the power supply member 2, is formed in the power supply member 2. Within the side wall of the power supply member 2, the communication path 9 is bifurcated into a communication path 9A and a communication path 9B. The communication path 9A opens at the side wall surface 3A of the inner cavity 3, and the communication path 9B opens at the base surface 3B of the inner cavity 3. An air breather 11, that incorporates therein a filter that removes corrosive gasses, is connected to the outer side opening portion of the communication path 9. However, a dry air supply unit such as a dry air supply line that supplies dry air or a moisture-removing filter, or an inert gas supply line that serves as an inert gas supplying means that supplies an inert gas such as argon gas or nitrogen gas or the like, may be connected to the outer side opening portion of the communication path 9 instead of the air breather 11.

An annular plate 12 formed in the shape of a donut is disposed at the side of the flange portion 10C of the rod-shaped electrode 10, which side is opposite the side at which the flange portion 5 of the power supply member 2 is located. Accordingly, the flange portion 10C of the rod-shaped electrode 10 is sandwiched between the flange portion 5 of the power supply member 2 and the annular plate 12.

Four bolts 7 are screwed-together with the flange portion 5 at uniform intervals. Four opening portions, through which the bolts 7 are inserted, are formed in the annular plate 12.

A coil spring 13, that is the spring member in the present invention, is inserted between a head portion 7A of each bolt 7 and the annular plate 12. The coil springs 13 push the flange portion 10C of the rod-shaped electrode 10 toward the power supply member 2 via the annular plate 12. Due thereto, the reduced-diameter portion 10A of the rod-shaped electrode 10 is pushed toward the inner cavity 3 of the power supply member 2. The biasing member of the present invention is structured by the annular plate 12, the flange portion 5, the bolts 7 and the coil springs 13. However, the spring member of the present invention is not limited to the coil springs 13. Washers having a spring operation, such as spring washers or disk washers for example, can be used instead of the coil springs 13. Further, the biasing member of the present invention is not limited to being structured by the annular plate 12, the flange portion 5, the bolts 7 and the coil springs 13. For example, an air actuator, a hydraulic actuator or a ball screw mechanism, which pushes the flange portion 10C of the rod-shaped electrode 10 toward the power supply member 2 either directly or via the annular plate 12, can be used as the biasing member.

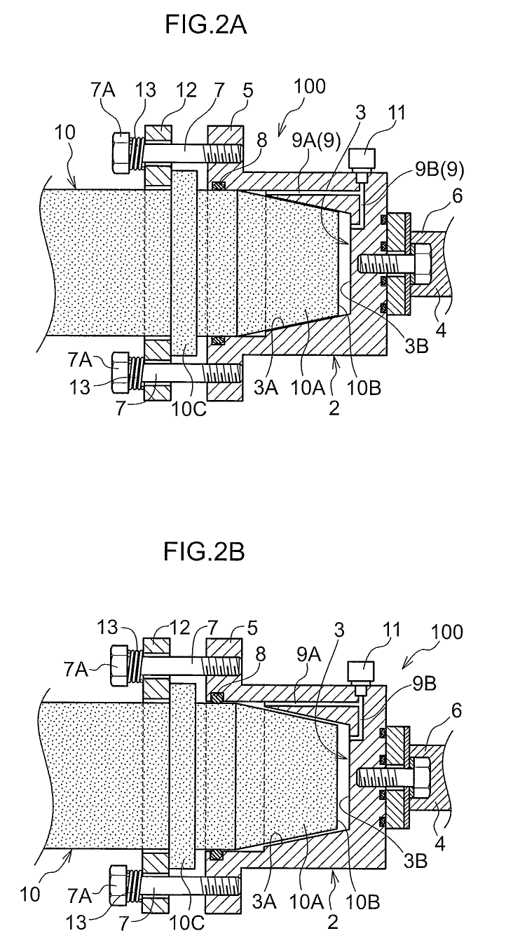

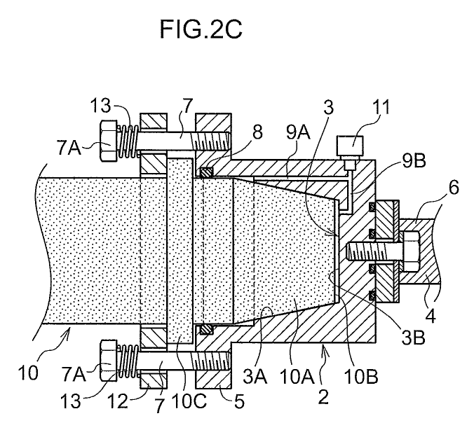

Operation of the power supply connection portion 100 according to exemplary embodiment 1 of the invention will be described hereinafter by referring to FIG. 2A to FIG. 2C.

As shown in FIG. 2A, in the state in which the power supply member 2 is attached to the rod-shaped electrode 10, the power supply member 2 is pushed toward the reduced-diameter portion 10A of the rod-shaped electrode 10 by the coil springs 13. Due thereto, the power supply member 2 and the rod-shaped electrode 10 are held such that the outer peripheral surface of the reduced-diameter portion 10A of the rod-shaped member 10 closely contacts the side wall surface 3A of the inner cavity 3 of the power supply member 2, and a gap is formed between the end surface 10B of the rod-shaped electrode 10 and the base surface 3B of the inner cavity 3 of the power supply member 2.

Here, when current is supplied to the rod-shaped electrode 10 from the feeder wire 4 via the power supply member 2, the power supply member 2 is heated by the current that flows through the power supply member 2, and thermally expands as shown in FIG. 2B. Due thereto, a gap is formed between the side wall surface 3A of the inner cavity 3 of the power supply member 2, and the outer peripheral surface of the reduced-diameter portion 10A of the rod-shaped electrode 10.

However, due to the pushing operation of the coil springs 13, as shown in FIG. 2C, the power supply member 2 is drawn toward the rod-shaped electrode 10; as the result, the side wall surface 3A of the inner cavity 3 of the power supply member 2 and the outer peripheral surface of the reduced-diameter portion 10A of the rod-shaped electrode 10 again closely contact one another.

In this way, the contact resistance at the power supply connection portion 100 according to exemplary embodiment 1 is low because, even when the power supply member 2 thermally expands due to current being supplied thereto, the side wall surface 3A of the inner cavity 3 and the outer peripheral surface of the reduced-diameter portion 10A of the rod-shaped electrode 10 are maintained in a closely-contacting state. Accordingly, an increase in the contact resistance between the side wall surface 3A of the inner cavity 3 and the outer peripheral surface of the reduced-diameter portion 10A of the rod-shaped electrode 10 and significant generation of heat are effectively suppressed.

An example has been described above of the power supply connection structure that uses, as an electrode, the rod-shaped electrode 10 that is shaped as a circular rod. However, in the present invention, the form of the portion of the electrode other than the end portions thereof is not particularly limited to a circular rod shape, provided that one or both of the end portions of the electrode are rod-shaped. Any of various forms such as prism-rod-shaped, block-shaped, or the like can be used.

### EXAMPLES

### 1. Example 1

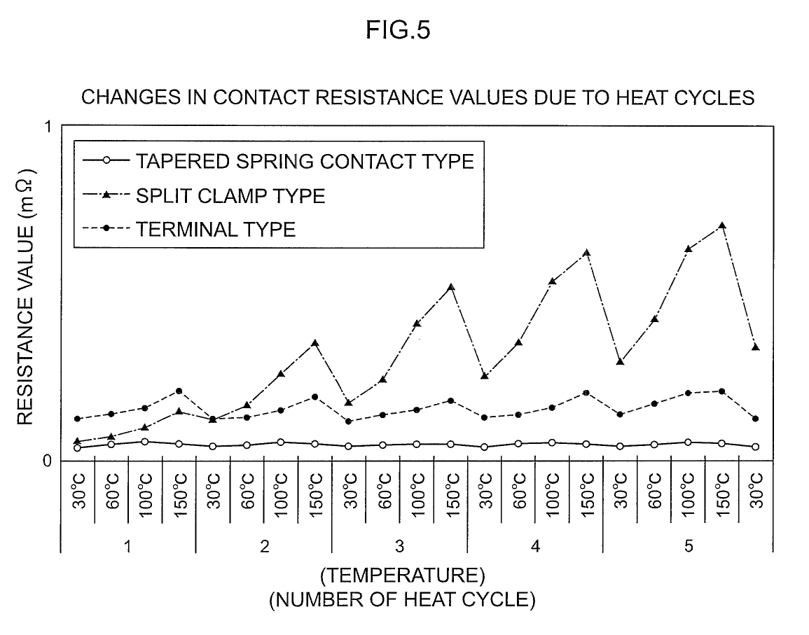

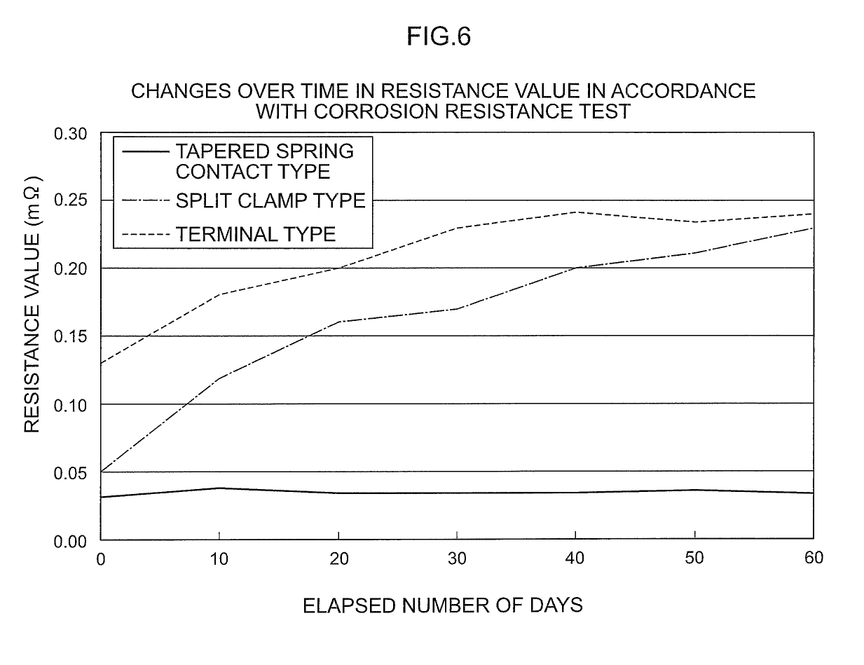

The power supply connection portion 100 of exemplary embodiment 1 was produced using, as an electrode, the rod-shaped electrode 10 that was shaped as a circular rod and formed from graphite. The dimensions of the connection portion of the rod-shaped electrode 10 were an outer diameter of 80 mm and a length of 100 mm. Further, the reduced-diameter portion 10A was made to be a taper shape (a truncated cone shape) of a taper ratio of 1/5. The effective pressure surface area was measured by using a pressure measuring film (PRESCALE (trade name) manufactured by Fujifilm Corporation). The results are shown in Table 1. Note that “tapered spring contact type” shown in Table 1 and in FIG. 5 and FIG. 6 that will be described later means the power supply connection portion 100 of exemplary embodiment 1.

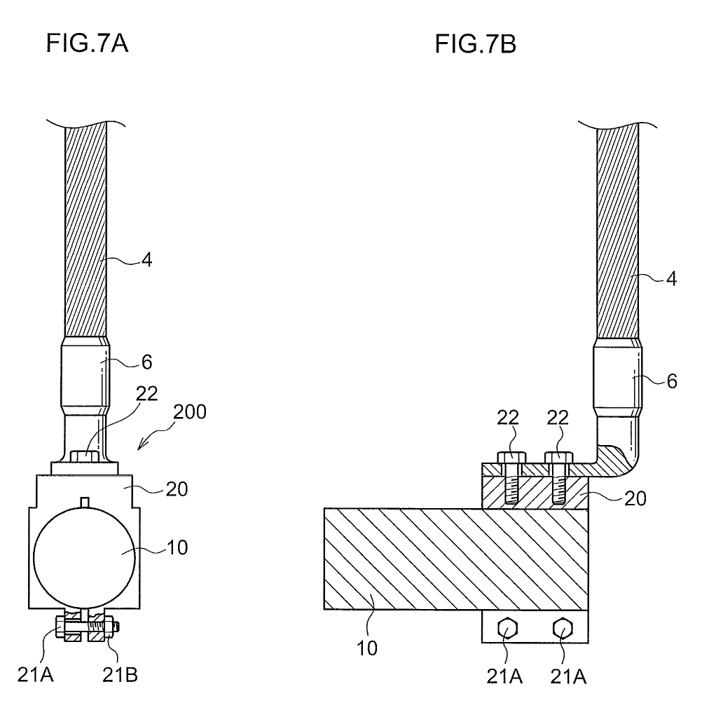

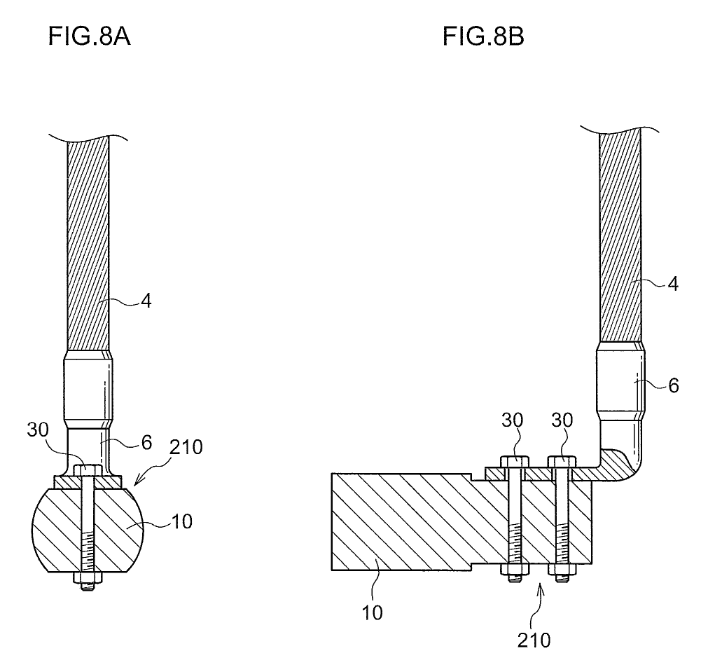

TABLE 1

| | | Type | | | | | |
|---|---|---|---|---|---|---|---|
| | | Tapered spring | | Split clamp | | Terminal | |
| | | contact type | | type | | type | |
| | | Contact surface shape | | | | | |
| | | tapered (1/5) | | cylindrical | | flat | |
| | | FIG. 1 | | FIGS. 7A & 7B | | FIGS. 8A & 8B | |
| Contact | Computed | 185 | cm² | 250 | cm² | 60 | cm² |
| surface | Effective | 165 | cm² | 140 | cm² | 55 | cm² |

| | | | | |
|---|---|---|---|---|
| area | Efficiency | 90% | 56% | 92% |

| | | | | | | |
|---|---|---|---|---|---|---|
| Contact resistance value | 0.04 | mΩ | 0.05 | mΩ | 0.13 | mΩ |

| | | | |
|---|---|---|---|
| Judgment | A | A | B |

As shown in Table 1, in the power supply connection structure of exemplary embodiment 1, the ratio of the effective contact surface area with respect to the contact surface area in theory is high at 90%, and accordingly, the contact resistivity exhibits a low value of 0.04 mΩ.

Next, a heat cycle, in which the power supply connection portion 100 was heated from 30° C. to 150° C. and thereafter was cooled to 30° C., was repeated five times in an electric furnace. The contact resistance at the power supply connection portion 100 before heating (i.e., the contact resistance at 30° C.), at the point in time when the temperature of the connection portion reached 60° C. during heating, at the point in time when the temperature of the connection portion reached 100° C. during heating, and at the point in time when the temperature of the connection portion reached 150° C. during heating, were measured. The results are shown in FIG. 5.

As shown in FIG. 5, the contact resistance of the power supply connection portion 100 was from 0.04 to 0.06 mΩ, and hardly showed any change at all in the five heat cycles.

Finally, after the power supply connection portion 100 was immersed in an acidic electrolytic liquid (a 1% nitric acid aqueous solution), the power supply connection portion 100 was left in air of normal temperature, and changes in resistance were investigated. The results are shown in FIG. 6.

As shown in FIG. 6, at the power supply connection portion 100, even after 60 days elapsed, 0.04 mΩ that was the initial value of the contact resistance was maintained.

### 2. Comparative Example 1

As shown in FIG. 7A and FIG. 7B, the end portion of the same rod-shaped electrode 10 as was used in exemplary embodiment 1 was not machined into a taper form, and was nipped by a split clamp 20. The split clamp 20 was tightened by bolts 21A and nuts 21B so as to fix the rod-shaped electrode 10. Next, the terminal 6 was connected to the end of the feeder wire 4, and the terminal 6 was fixed to the split clamp 20 by bolts 22 such that a power supply connection portion 200 was formed. The “split clamp type” shown in Table 1, FIG. 5 and FIG. 6 means the power supply connection portion 200 according to Comparative Example 1.

The effective pressure surface area and the initial contact resistance of the power supply connection portion 200, that was structured as described above, were measured in the same way as in Example 1. The results are shown in Table 1. As shown in Table 1, at the power supply connection portion 200, the effective pressure surface area was small at 56%, and the contact resistance was low at 0.05 mΩ.

Next, the same heat cycle as in Example 1 was repeated 5 times, and the contact resistance at the power supply connection portion 200 before heating (i.e., the contact resistance at 30° C.), at the point in time when the temperature of the connection portion reached 60° C. during heating, at the point in time when the temperature of the connection portion reached 100° C. during heating, and at the point in time when the temperature of the connection portion reached 150° C. during heating, were measured. The results are shown in FIG. 5.

As shown in FIG. 5, at the power supply connection portion 200, the contact resistance increased as the temperature rose from 30° C. to 60° C., 100° C. and 150° C. Further, as the heat cycles were repeated, the values of the entire V-shaped peak of the contact resistance increased to markedly higher values.

Finally, after the power supply connection portion 200 was immersed in an acidic electrolytic liquid, the power supply connection portion 200 was left in air of normal temperature, and changes in resistance were investigated. The results are shown in FIG. 6.

As shown in FIG. 6, at the power supply connection portion 200, the contact resistance also increased as the number of days elapsed. The initial value of 0.05 mΩ rose to 0.23 mΩ after 60 days elapsed.

### 3. Comparative Example 2

As shown in FIG. 8A and FIG. 8B, a pair of planar surfaces were formed at the end portion of the same rod-shaped electrode 10 as was used in exemplary embodiment 1. Through-holes, that passed-through from one of these planar surfaces toward the other, were formed. The terminal 6 of the feeder wire 4 was fixed to the one planar surface by bolts 30 that passed-through the through-holes, and a power supply connection portion 210 was formed. The “terminal type” shown in Table 1, FIG. 5 and FIG. 6 means the power supply connection portion 210 according to Comparative Example 2.

The effective pressure surface area and the initial contact resistance of the power supply connection portion 210, that was structured as described above, were measured in the same way as in Example 1. The results are shown in Table 1. As shown in Table 1, at the power supply connection portion 200, the effective pressure surface area was 92% and higher than that of Example 1, but the contact resistance was high at 0.13 mΩ.

Next, the same heat cycle as in Example 1 was repeated five times, and the contact resistance at the power supply connection portion 210 before heating (i.e., the contact resistance at 30° C.), at the point in time when the temperature of the connection portion reached 60° C. during heating, at the point in time when the temperature of the connection portion reached 100° C. during heating, and at the point in time when the temperature of the connection portion reached 150° C. during heating, were measured. The results are shown in FIG. 5.

As shown in FIG. 5, at the power supply connection portion 210, the contact resistance increased markedly more than that of Example 1 as the temperature rose from 30° C. to 60° C., 100° C. and 150° C. Further, it was clearly recognized that, as the heat cycles were repeated, the V-shaped peak of the contact resistance increased to higher values.

Finally, after the power supply connection portion 210 was immersed in an acidic electrolytic liquid, the power supply connection portion 210 was left in air of normal temperature, and changes in the resistance were investigated. The results are shown in FIG. 6.

As shown in FIG. 6, at the power supply connection portion 210, the contact resistance also increased as the number of days elapsed. The initial value of 0.13 mΩ rose to 0.24 mΩ after 60 days elapsed.

All publications, patent applications, and technical standards mentioned in this specification are herein incorporated by reference to the same extent as if each individual publication, patent application, or technical standard was specifically and individually indicated to be incorporated by reference.

What is claimed is:

1. A power supply connection structure comprising:
an electrode which has at least one end portion that is a rod-shaped portion, and which has, in a vicinity of an end surface of the rod-shaped portion, a reduced-diameter portion having a diameter that is reduced toward the end surface;
a power supply member which is formed from a conductor and to which is connected a feeder wire that supplies current to the electrode, the power supply member having an inner cavity that is a concave portion formed such that the circumference of a side wall of the inner cavity is reduced toward a base surface of the inner cavity, and, due to the reduced-diameter portion of the electrode being inserted in the inner cavity, the power supply member is attached to the reduced-diameter portion of the electrode; and
a biasing member which pushes the power supply member, that is attached to the reduced-diameter portion of the electrode, toward the reduced-diameter portion,
wherein the power supply member is formed such that, in a state in which the power supply member is attached to the reduced-diameter portion of the electrode, the side wall surface of the inner cavity closely contacts an outer peripheral surface of the reduced-diameter portion of the electrode, and a gap is formed between the base surface of the inner cavity and the end surface of the electrode at the reduced-diameter portion of the electrode.

2. The power supply connection structure of claim 1, wherein the biasing member comprises a spring member which pushes the power supply member toward the reduced-diameter portion of the electrode.

3. The power supply connection structure of claim 1, wherein a sealing member, which prevents external air and liquid from entering between the inner cavity and the reduced-diameter portion of the electrode, is provided in a vicinity of an edge portion at the inner cavity of the power supply member.

4. The power supply connection structure of claim 1, wherein a communication path, which communicates the inner cavity with the exterior of the structure, is provided at the power supply member.

5. The power supply connection structure of claim 4, further comprising a dry air supply unit which supplies dry air, via the communication path of the power supply member, to a space between the inner cavity of the power supply member and the reduced-diameter portion of the electrode.

6. The power supply connection structure of claim 4, further comprising an inert gas supply unit which supplies inert gas, via the communication path of the power supply member, to a space between the inner cavity of the power supply member and the reduced-diameter portion of the electrode.

7. An electrolytic processing device comprising:
an electrolysis tank in which an electrolytic processing liquid is stored;
a web conveying unit for conveying a web, which is to be subjected to electrolytic processing, through the interior of the electrolysis tank along a predetermined conveying path; and
an electrode that is disposed at the interior of the electrolytic tank along the conveying path of the web, and to which a feeder wire is connected by the power supply connection structure of claim 1,
wherein the electrolytic processing device electrolytically processes the web by supplying alternating current or direct current through the feeder wire to the electrode.
